(19) United States
(12) Patent Application Publication
(10) Pub. No.: US 2020/0189902 A1
(43) Pub. Date: Jun. 18, 2020

(54) SYSTEM AND METHOD FOR STRAIN GAGE WATER MONITORING

(71) Applicant: DS SERVICES OF AMERICA, INC., Atlanta, GA (US)

(72) Inventor: Bruce D. Burrows, Valencia, CA (US)

(73) Assignee: DS SERVICES OF AMERICA, INC., Atlanta, GA (US)

(21) Appl. No.: 16/222,183

(22) Filed: Dec. 17, 2018

(51) Int. Cl. B67D 3/00; G01F 9/00; G01F 23/20; G01M 3/32

(52) U.S. Cl. CPC B67D 3/00; G01M 3/32; G01F 23/20; G01F 9/003

(57) ABSTRACT

A system and method determines an amount of water and water flow rate in a water dispenser system including a container/bottle, using a strain gage device(s) mounted on a structure or plane in relationship to the container/bottle. One or more strain gages are configured in a position to measure force per unit area, exerted by a portion of the water container/bottle in a normal or direction substantially perpendicular to a surface or plane on which the strain gage device(s) are mounted. The portion of the container/bottle is positioned in direct or indirect contact with the one or more strain gages to produce a strain gage signal representative of the amount of water in the container/bottle and periodic sampling of the strain gage signal is representative of flow rate of water from the container/bottle. Signals from the strain gage(s) are processed in a manner that allows the amount and rate of consumption of water to be monitored and determined automatically on-site or remotely.

### TECHNICAL FIELD

Aspects of the present disclosure generally relate to apparatuses and methods for water dispensing systems, and servicing of water dispensing systems.

### BACKGROUND

Water is necessary for human existence. In many parts of the world, clean drinking water is difficult to obtain. Many different types of water purification and dispensing systems and methods have been employed to provide clean drinking water throughout the world.

Although many municipal water systems provide clean and/or purified drinking water, water dispensing systems have become popular in many offices and homes. In some water dispensing systems, such as illustrated in FIG. 1A, a pre-filled container of purified water may be present to store purified water for on-demand use. The water from the container may be transported within the system from a receiver for mounting the container to a spigot for delivering the water. Such systems typically utilize interior plumping to transport the water through the system from the intake point, where the water enters the system from the container, to the outflow point where the water is ultimately delivered.

The pre-filled containers are often replaceable bottles, such as illustrated in FIG. 1B, typically ranging in size from three to five gallons. However, once the container is emptied the water purification system may be unable to provide purified water until the container is replaced. These containers, when full, are heavy and may be difficult to handle (e.g., with water weighing roughly eight pounds per gallon a 5 gallon bottle will weigh approximately 40 pounds). In order to replace the container, someone at the establishment where the dispenser is located (or a service worker) needs to remove the empty container and lift a full, heavy container and properly locate it into the dispenser. If container replacement needs to be done by a service person, the service person must make an on-site visit, remove the empty container and install a new container. During removal or reinstallation, critical components of the system may be exposed and become damaged. If the full replacement container is improperly placed/seated in the system, a leak may be created and/or fluid lines, seals, or other mechanical components within the plumbing of the system may be damaged necessitating a service call.

Water flow in known dispensers may be measured or tracked using a rotary flow meter. Such rotary flow meters are generally mechanical components that may be susceptible to mechanical failure. These flow meters typically are mounted in-line with the plumbing of the water dispensing system, and generally operate by having an impeller or a plurality of paddles located within a chamber. As the water flows through the chamber, the impeller or paddles are turned by the flowing water. An axis upon which the paddles are mounted in the chamber is rotated, and the flow sensor is configured to generate a magnetic field measured by a hall sensor to represent the flow rate of the water. From the flow rate of the water, the rate of water consumption may be calculated and the amount of water remaining in the container correspondingly determined.

Water dispensing systems have also used rotary vane flow meters in an attempt to reduce backwash in the system. The rotary vane flow meter is a modified rotary flow meter utilizing a number of retractable vanes configured to expand or retract to maintain contact with the chamber walls. The vanes rotate about an off-center axis to isolate fixed amounts of liquid between the vane and the chamber wall. These flow meters may use springs or hydraulic fluid to allow the vanes to retract and expand depending on the rotation of the vanes. The rotation and retraction of the vanes assists the water to flow out of the chamber towards the dispenser or spigot where the water is delivered.

Mechanical flow components may suffer from wear and tear resulting in breakdowns, deterioration, and impediment of the flow of water through the water dispensing system, potentially creating service problems. The rotary vane flow meters also present the risk of the spring breaking or the hydraulic fluid leaking into the water flow thereby contaminating the purified drinking water. Additionally, the surface area of the impeller, paddles, and vanes may create a potential platform for the growth of harmful bacteria and other organisms, particularly where air is present in the system, such as when the system is fully drained due to a failure to replace the container before the container is emptied. Mechanical flow metering devices create drawbacks and may negate the benefit of using a container pre-filled with filtered and/or purified water.

### SUMMARY

The present disclosure provides water dispensing systems and associated methods that monitor the consumption of water and avoid the problems associated with mechanical flow metering components. Water dispensing systems and methods according to the disclosure monitor and determine amount of water in the dispenser container/bottle using strain gage device(s) mounted on a structure or plane in relationship to the bottle. Signals from the strain gage(s) in the disclosed system and methods are processed in a manner that allows the amount and consumption of water to be monitored and determined automatically on-site or remotely. The systems and methods avoid potential mechanical failures, damage from aeration, and bacterial growth by removing mechanical components from within the plumbing of the system as would be presented by mechanical flow metering devices.

According to the disclosure, the water dispenser system is configured to mount a container in a receiver of the dispenser system. The receiver is configured with an abutment surface (e.g., planar surface) in direct or indirect contact with one or more strain gages positioned to be at least partially beneath a portion of a water container/bottle disposed in the receiver of the dispenser. The one or more strain gages are configured in a position to measure normal stress, i.e. a measure of force per unit area, exerted by the portion of the water container/bottle in a normal or direction perpendicular to the surface or plane of the receiver. The portion of the container/bottle is positioned in direct or indirect contact with the one or more strain gages to produce a strain gage signal representative of the amount of water in the container/bottle. Strain gage signal conditioning components receive and condition the strain gage signal and communicate a conditioned strain gage signal to a processor or microcontroller. The processor or microcontroller determines water amount in the container from the strain gage signal, and may monitor the water amount over time to determine flow of water from the container/bottle. The processor or microcontroller may be associated with communications technologies, such as cellular or Bluetooth technology, to make the water amount and/or flow data available for transmission to one or more hand held devices and/or a server.

In one configuration, in a top fill dispenser, a portion of surface of a neck of an inverted bottle is disposed on or in a receiver in fluid communication with the plumbing of the system of the water dispenser system. The receiver may have a surface, e.g., a planar surface, that includes at least one strain gage disposed thereon. The strain gage is configured to measure the normal stress associated with the water bottle, and to convert a strain gage signal to a signal representative of the amount of water in the container/bottle. Measurements of the amount of water at periodic intervals, or continuously over time, can be used to measure the flow rate of water from the container to determine the remaining amount of water in the container. That is, one or more strain gages are used to determine the amount of water within the container, and to measure the flow rate by determining the changing weight of the container against the strain gages disposed on a surface of the receiver.

In another configuration, in a bottom fill dispenser (i.e. where a water bottle or container is not inverted at the top of the dispenser to supply water but instead the container is located in a cabinet or on a shelf below a reservoir and spigot), a portion of surface of a bottom of the container or bottle is disposed on a surface, e.g., a planar surface, that includes at least one strain gage disposed thereon. The strain gage is configured to measure the normal stress associated with the water container/bottle, and to convert a strain gage signal to a signal representative of the amount of water in the container/bottle. Measurements of the amount of water at periodic intervals, or continuously over time, can be used to measure the flow rate of water from the container and to determine the remaining amount of water in the container. That is, the flow rate may be determined, according to the disclosure, as a function of the change in volume of water present in the container over time.

Again, one or more strain gages are used to determine the amount of water within the container, and to measure the flow rate by determining the changing weight of the container against the strain gages.

According to the disclosure, a monitoring system, such as a specially configured processor, may be pre-programmed with an acceptable flow rate range for the system. If the detected flow rate varies from within the pre-programmed range, the monitoring system may signal a leak or other error as the cause of the flow rate being outside the acceptable range. The system may record the occurrence of the error, display an error message and/or communicate the error to an online monitoring system and/or to a service person's hand held device and/or server. The error may prompt the service person to perform an on-site inspection of the water dispensing system. The system may also be programmed to record the remaining amount of water in the container and send an alert when the amount of water reaches a predetermined amount. As a result, a service worker may be dispatched or notified to service the system whether to fix a leak and/or replace a nearly empty container. In doing so, the time that the water dispensing system is offline for maintenance is reduced and gaps in service may be prevented. Additionally, the automatic reporting by the system may eliminate the need for standing appointments with the service worker for traveling to the system's location to verify the integrity of the system.

The water dispensing system may further include a user interface configured to display the remaining amount of water in the container, among other information. The user interface may include prompts and notifications regarding recorded errors and options for arranging on-site servicing of the system at the owner's convenience.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1A illustrates a conventional water bottle-fed, top fill water dispensing system as known in the art.

FIG. 1B illustrates a conventional water bottle for a bottle-fed, top fill water dispensing system as known in the art.

FIGS. 2A-2C illustrate different views and components of a receiver for receiving an inverted water bottle in a water dispensing system using strain gages to determine water amount and flow according to the disclosure.

FIGS. 3A and 3B illustrate a perspective view and an exploded view, respectively, of a receiver of a top fill water dispensing system.

FIG. 4 illustrates a block diagram of components of a system using strain gages to determine water amount and flow according to the disclosure.

FIG. 5 is a flow diagram of using strain gages to determine water amount and flow according to the disclosure.

FIG. 6 is a diagram of an example of a bottom fill dispenser in which strain gages may be used to determine water amount and flow according to the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

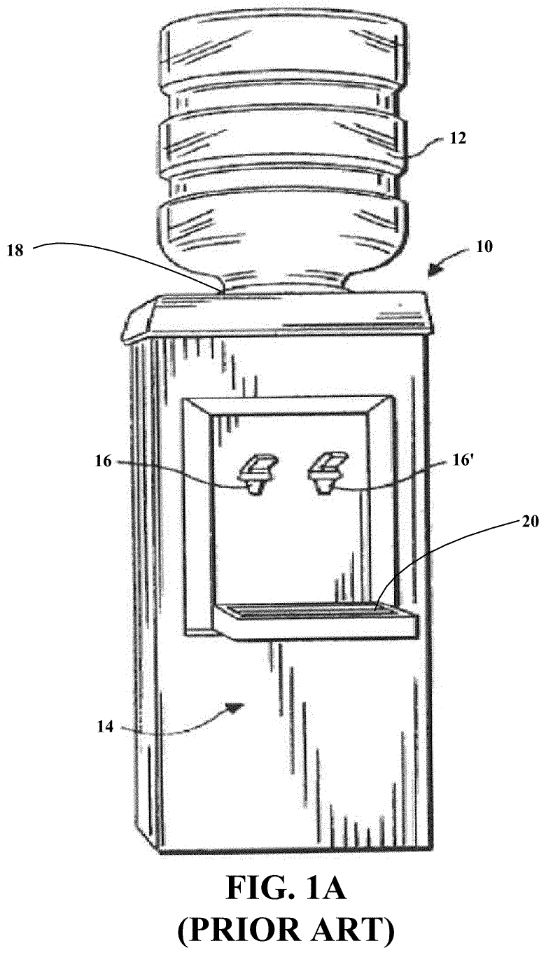

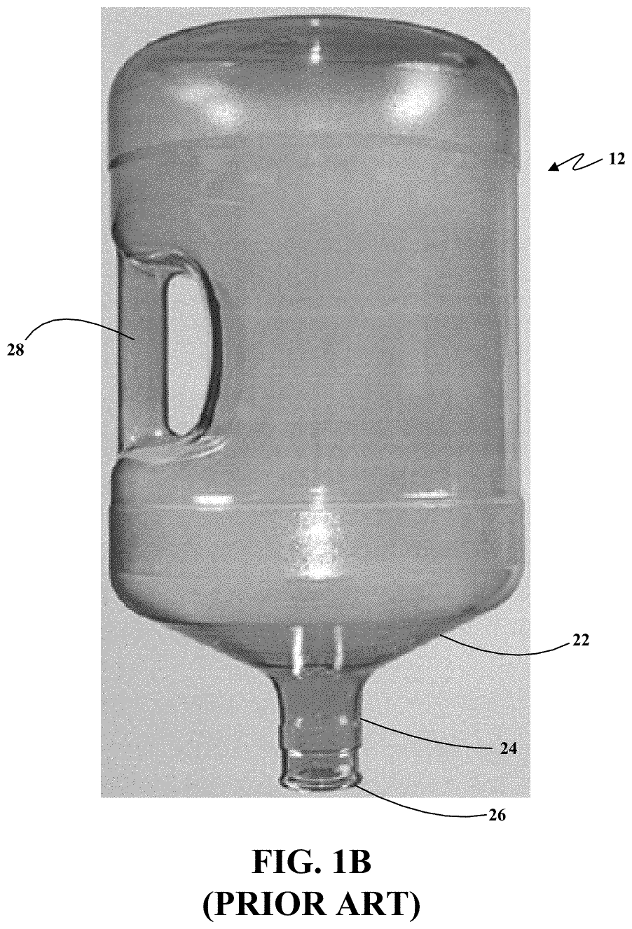

FIG. 1A illustrates a conventional water bottle-fed, top fill water dispensing system 10 as known in the art. The present disclosure provides improvements to such water dispensing systems and associated methods that monitor the consumption of water and avoid the problems associated with mechanical flow metering components.

Referring to FIG. 1A, the known water dispensing system 10 includes a bottle 12 disposed at an upper end of the system and inverted to provide gravity-fed water from the bottle 12 into the dispensing system 10. A stand 14, includes at least one spigot 16, 16′ and a receiver 18 for the inverted bottle 12 to engage the dispenser system 10 and be retained in engagement with the stand 14. The spigots 16, 16′ are typically one for hot water and one for cold water, and include a handle for manual actuation of a valve by a user to control the outflow of water. A drip tray 20 is located below the spigots to contain any drips or spilled water beneath the spigots.

In operation, water from the inverted bottle 12 flows down out of the bottle disposed in the receiver. Often, a well or reservoir (not depicted in FIG. 1A) receives the water and retains it for release upon the opening of one of the spigots. However, previous systems either did not monitor the flow rate of the water, or did so using a mechanical component such as a rotary flow meter or rotary vane flow meter. The flow meter measured the flow rate of the water travelling from the bottle or well to the spigot(s). The flow meter would be disposed within internal plumbing of the system. As a result, the water flowed through the flow meter on the way to the spigot.

FIG. 1B is an illustrative embodiment of a known container/bottle 12 used in bottle-fed, top fill water dispensing systems. Known bottles typically contain filtered water for supplying from the water dispensing system. The bottle 12, includes a shoulder 22 that tapers down to a neck portion 24. The neck 24 has a lip 26 at an opening of the bottle 12 at the end of the neck 24. A handle 28 may be formed in the container material or attached to the bottle 12 for carrying. The bottle 12, shoulder 22, neck 24 and lip 26 are configured to be received in an inverted position by the receiver 18 of the dispensing system 10.

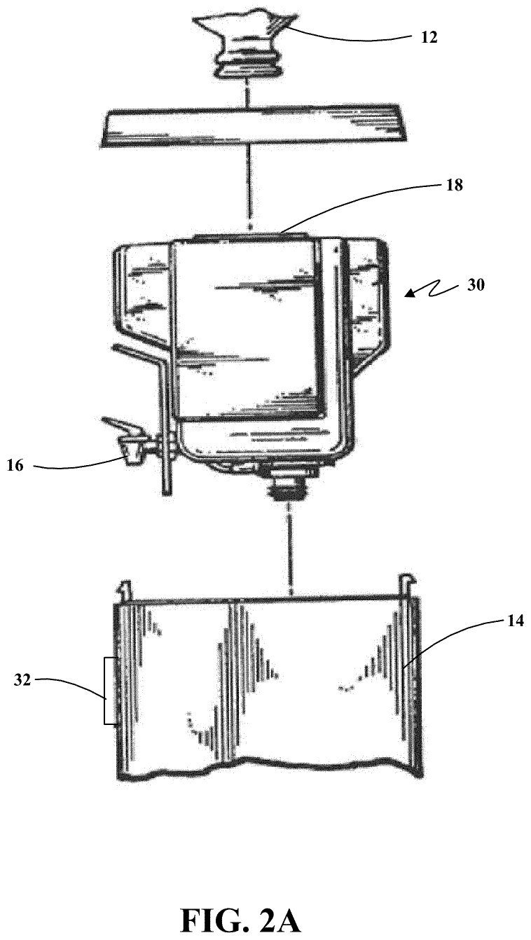

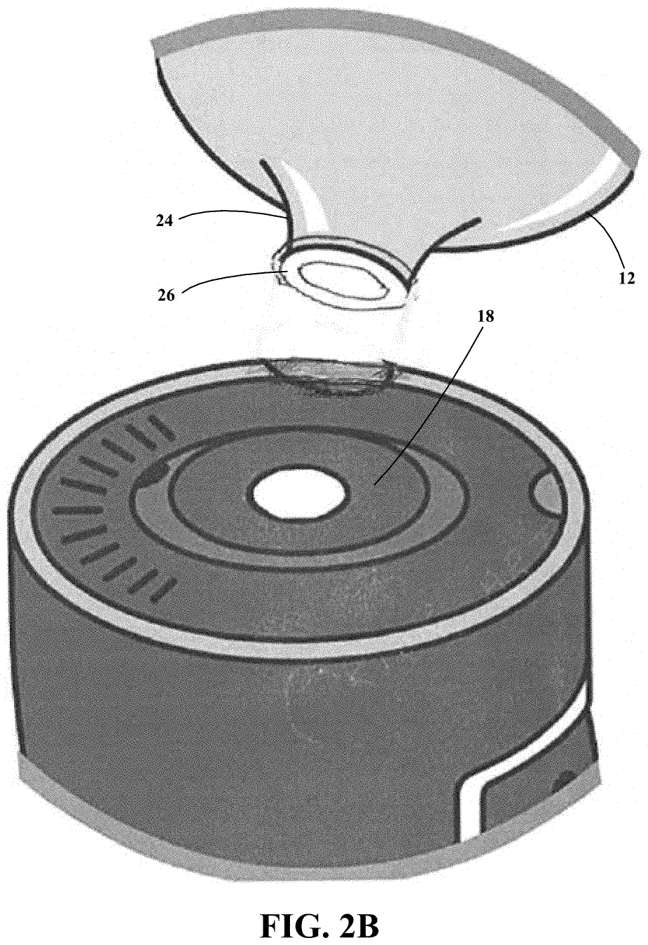

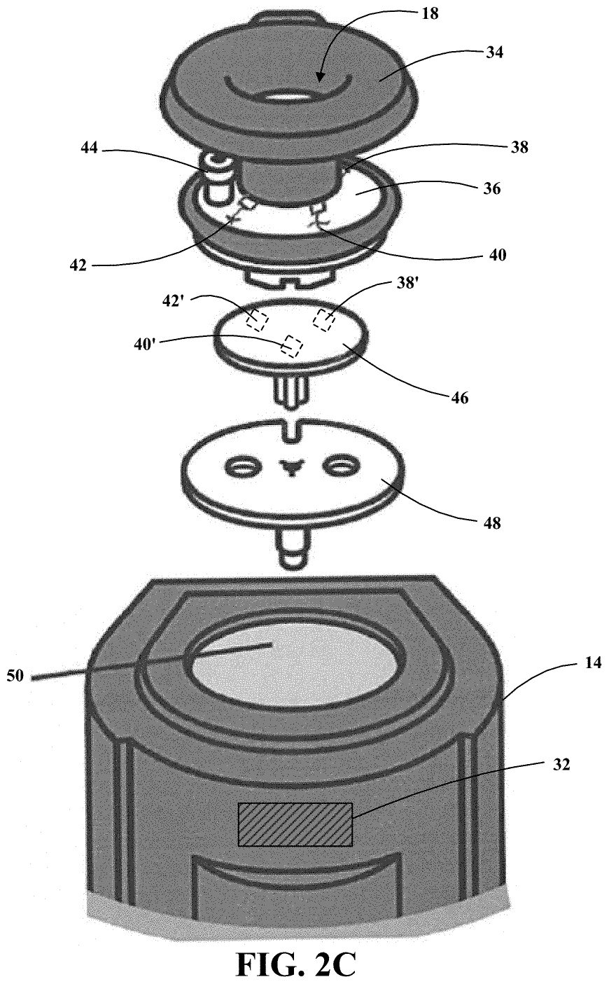

FIGS. 2A-2C illustrate exploded views of components of the water bottle-fed, top fill water dispensing system 10 according to the disclosure. In one embodiment of an improved water dispensing system, strain gage(s) are integrated to determine the amount of water within the bottle, and to measure the flow rate by determining the changing weight of the bottle against the strain gages, as described in detail hereinafter. In an alternative embodiment, the bottle 12 or other container may be stored in an upright position in a cabinet of the water dispensing system with the bottle 12 or other container in engagement with strain gages to determine the amount of water within the bottle or container, and to measure the flow rate by determining the changing weight of the container against the strain gages.

In FIGS. 2A-2C a stand 14 is depicted for housing a dispenser unit 30. The dispenser unit 30 includes internal plumbing for transporting water to the spigot(s) 16 from the bottle 12 invertedly disposed within the receiver 18. Additionally, a user interface 32 may be located on the surface of the stand 14 of the water dispensing system for displaying monitored information, alerts, and messages generated by the system. The user interface 32 may include at least one LED, or LCD or LED display screen, or the like.

The receiver 18 may comprise a number of components (best illustrated in FIG. 2C) such as a flexible shoulder brace 34 to provide abutment surfaces against which the shoulder of the inverted bottle is braced against lateral movement when the neck 24 of the bottle is disposed in the receiver 18. Beneath the shoulder brace 34, the receiver 18 may have a bottle lip engagement surface, e.g., a planar surface 36, that includes at least one strain gage disposed thereon. The bottle lip engagement surface, or planar surface, 36 is a surface against which the lip 26 of the bottle 12 rests when the bottle 12 is disposed in the receiver 18. As illustrated, the at least one strain gage may comprise three strain gages 38, 40, 42 disposed substantially equidistant around the circumference circumscribing the lip 26 of the bottle 12, and positioned to engage (directly or indirectly) the lip of the bottle.

As seen in FIGS. 2B and 2C the receiver may comprise a well beneath the receiver 18 that receives the inverted bottle 12 and accepts the water exiting the bottle. The receiver components (best seen in FIG. 2C) may include an air filter 44 for replacing the water in the bottle with filtered air. The filter prevents contamination from entering the bottle and contaminating the water. The strain gage(s) may be configured to directly measure the weight of the bottle 12 against the strain gages 38, 40, 42, or they may be configured to measure the weight of the bottle against other structures, e.g., a plate 46 within the well, having strain gage(s) 38′, 40′, 42′ disposed thereon. The strain gage(s) may be calibrated to determine the weight of the plate 46 within the well without the container as a control value. Alternatively, the strain gage(s) may measure the weight of the plate 46 within the well plus an empty container as the control value, for example. A separator 48 may distribute the water as it enters the water dispensing system for heating or cooling the water to a designated temperature. The water may then be held in at least one reservoir 50 prior to dispensing to a system user.

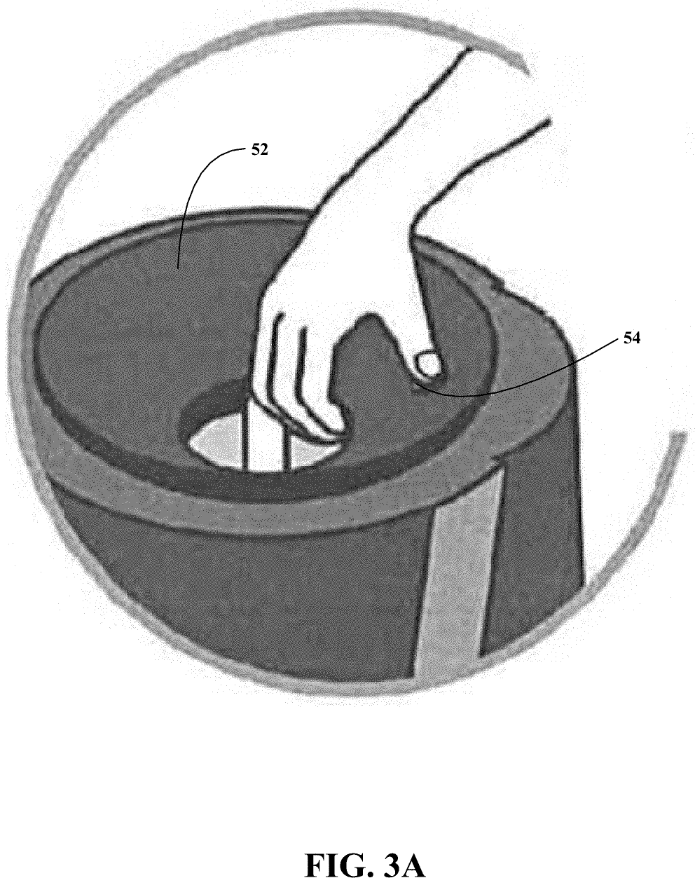

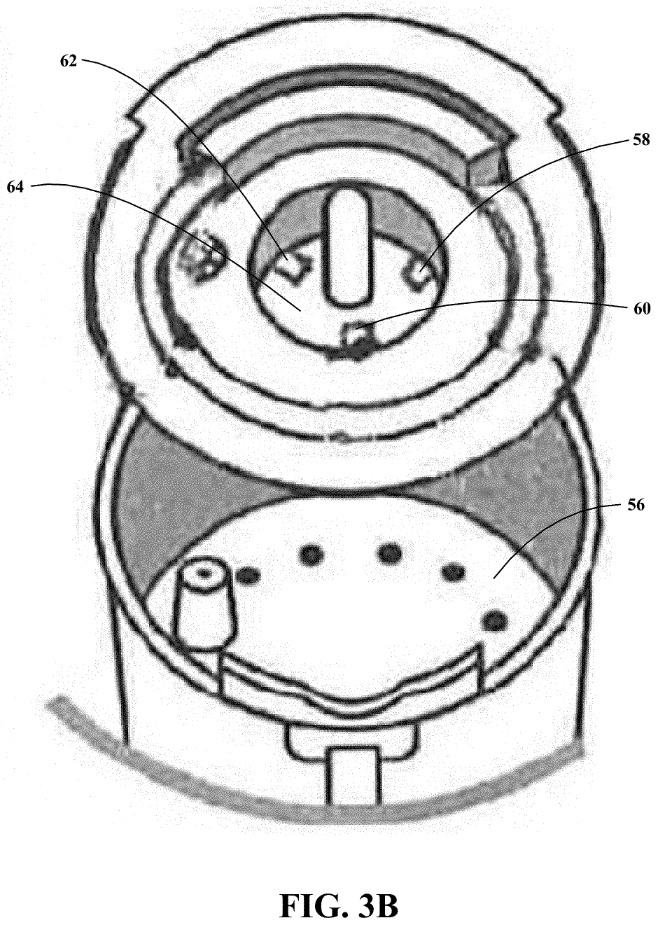

Turning to FIGS. 3A and 3B, in an embodiment according to the disclosure, the receiver may have a cover 52 for laterally stabilizing the inverted bottle. The cover 52 may be fastened to the receiver using a latch 54. The receiver may also include a separator 56 (FIG. 3B) for distributing water entering the system to different reservoirs for conditioning the water to a predefined temperature. Strain gage(s) 58, 60, 62 may be disposed on a substantially planar surface 64 in the well beneath the receiver between the cover 52 and the separator 56. With the neck of the water bottle in the receiver, the weight of the bottle is measured by the strain gage(s) to determine/measure the remaining water amount within the container and also the flow rate of water exiting the container.

The strain gage(s) as described herein, e.g., strain gages 38, 40, 42 (or strain gages 38′, 40′, 42′ or strain gages 58, 60, 62), are configured to measure the force exerted by the bottle on the lip engagement surface, or planar surface (or indirectly, surface(s) in engagement with the lip engagement surface, or planar surface), of the water dispensing system. In an illustrative embodiment, more specifically, each strain gage is configured to measure the normal stress associated with the water bottle, and to convert a strain gage signal to a signal representative of the amount of water in the container/bottle. Measurements of the amount of water at periodic intervals, or continuously over time, can be used to measure the flow rate of water from the container to determine the remaining amount of water in the container. That is, one or more strain gages are used to determine the amount of water within the bottle, and to measure the flow rate by determining the changing weight of the bottle against the strain gages.

The flow rate may be determined, according to the disclosure, as a function of the change in volume of water present in the container over time. For example, the strain gage may measure a change in weight applied to the gage over a period of time. The weight change is a result of water exiting the container over that time period. As the water flows out, the volume, and therefore the mass, of the water present in the container changes. Gravitational force acting on the mass of the container and the water within is a constant known in the art. Therefore, the strain gage's measurement of the weight of the container and the water at intervals leads to a record of the change in water volume reflected over a measured time period. By taking the change in volume derived from the change in weight, over the change in time, a calculation of the flow rate may be achieved. Flow rate may be represented as: Q_Flow=dV/dt where dV is the change in volume and dt is the change in time.

The receiver of the illustrative embodiments of the water dispensing system(s) according to the disclosure holds the bottle in an inverted position, typically referred to as a top fill system, and distributes the weight of the bottle onto a surface or structure in the system that is in relation to the strain gage(s) (e.g., the strain gages may be disposed on the surface or in contact indirectly with structure abutting the bottle). The strain gage(s) measures the force, or weight, of the bottle. In some embodiments, the strain gages may operate by measuring the change in resistance of a wire internal to the strain gage to determine the pressure acting on the strain gage. Strain gages use a change in pressure over the surface area of the strain gage, hereinafter referred to as a force, to create changes in the resistance of a wire. The wire is lengthened or shortened in reaction to the applied force thereby creating strain within the wire. As a pressure is exerted on the strain gage(s) disposed in the water dispensing system, the length of the wire changes, either due to compression or expansion. The change in wire length results in a measureable change to the wire's resistance. A person of ordinary skill in the art will appreciate that force is a pressure over an area and that the imperial measurement for weight is a measurement of force as exerted on the strain gage(s). As the strain changes, the resistance of the wire changes in proportion. A current flow through the wire is measured to determine the change in resistance.

The change in resistance may be used to calculate the change in force being applied to the strain gage. The force may be used to determine the weight of water (i.e. amount of water) in the bottle. For example calculations relating magnitude of resistance to weight may be used, or a look-up table may be used to find weight of water corresponding to specific resistance values of the strain gage. The change in force may then be used to determine the change in weight of the bottle and the flow rate of water leaving the bottle. An example of strain gages that may be used according to the disclosure are the LY Linear Strain Gage, available from HBM of Marlborough, Mass., or the KFRP Series Strain Gage available from KYOWA of Tokyo, Japan, or the like.

The strain gages effectively measure the weight of the bottle to determine the remaining water amount within the bottle, and uses changes in the weight applied to the gage to calculate the flow rate of water within the water dispensing system. As the bottle/container empties of water, the weight decreases until the bottle is depleted of water, or until the bottle is emptied to a point at which it may be desirable to issue an alarm or warning or disable the flow path of water from the dispenser.

The strain gage(s) may be insulated from temperature changes and calibrated to account for drift. Strain gages may be susceptible to temperature changes and so may be disposed in alternative locations of the system without deviating from the scope of the disclosure. Additionally, the system may include at least one control strain gage (hereinafter referred to as a “CG”). The CG(s) may be disposed adjacent to the strain gage(s) but not receive a pressure input. As a result, any change in the CG output is due to temperature variance. Thus, the CG output may be a calibration input, e.g. to a processor, used to remove temperature interference in the output of the strain gage(s).

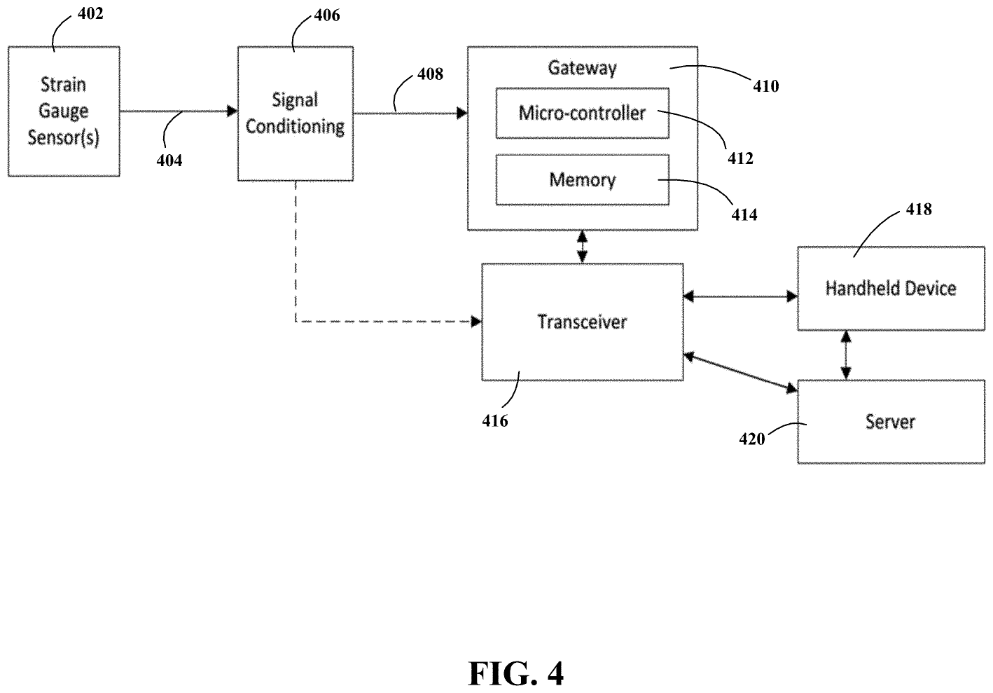

FIG. 4 illustrates a block diagram of the system components and signal flow for the dispenser using strain gages to determine water amount and flow according to the disclosure. The strain gage sensor(s) 402, as described in detail hereinbefore, are disposed in the dispenser system to measure a pressure/weight of the container/bottle exerted against the strain gage(s). The strain gage(s) measurements provide a strain gage signal 404 that may be output as an analog signal representative of the amount of water in the bottle. The strain gage signal 404 may need to be converted from analog form to a digital signal, such as by an analog to digital converter, and/or otherwise subjected to signal conditioning 406. For example, signal conditioning 406 could be in the form of excitation, amplification and/or eradication of noise from the signal. A conditioned strain gage signal 408 may be sent to a gateway 410 for processing by a processor or micro-controller 412, for example to convert the instantaneous signal to a weight (e.g., in pounds, ounces, kilograms, grams) or other unit of measure (e.g. gallons, quarts, pints, cups, liters). The micro-controller may be any of various suitable micro-controllers, such as an ST Micro STM 32F401RE available from STMicroelectronics, or similar device. The micro-controller may store the converted digital data, indicating the amount of water in the bottle, to a memory 414 associated with the micro-controller 412.

Alternatively, or in addition, the digital data, e.g. representing weight or amount of water in the bottle/container may be directly sent to a transceiver 416. The transceiver 416 may be separate from or a part of the gateway 410. The transceiver 416, as part of or separate from the gateway 410, may be configured to transmit the data wirelessly, e.g., via Bluetooth, Bluetooth Low Energy (BLE) or Zigbee, and/or it may be configured with cellular modem technology for wide area wireless communication (such as 4G LTE CAT M1 Embedded Modem technology available from NimbeLink Corp., Plymouth, Minn.).

Either the micro-controller 412 or signal conditioning circuitry 406 may put the conditioned strain gage signal 408, representing water amount and/or flow according to the disclosure, into packets for further communication. Either the micro-controller 412 or transceiver 416 may store the conditioned strain gage signal 408, representing water amount and/or flow rate, in the memory 414 associated with the micro-controller. The transceiver 416, either as a component separate from or a part of the gateway 410, may send an information packet comprising computed water amount and/or flow rate to a handheld device 418 (such as may be in the possession of a service worker), or to a server 420 that may store information from a plurality of gateways monitoring a plurality of devices such as the water dispenser according to the disclosure. The gateway 410 in conjunction with the transceiver 416 may be configured to send information packets continuously or at predetermined intervals. An error or alert message, as determined by the gateway 410, may be programmed to bypass the interval and be sent immediately upon generation. It should be appreciated that although wireless communications are described, the information packet may be distributed through an over-air/wireless connection or a hardwire connection.

The gateway 410 may be configured to calculate the flow rate of the water, as a function of change of weight of the container/bottle within the water dispensing system over time, and compare the flow rate to a pre-defined threshold or range. If the flow rate is above a threshold value, for example a value in memory that indicates the “normal” reduction in weight of the container/bottle over time when a spigot is open, an error message or alert may be generated (for example indicating a leak). If the flow rate is below a lower threshold value, for example a value in memory that indicates the “normal” reduction in weight of the container/bottle over time when a spigot is open, and that flow rate value persists over an extended period of time, an error message or alert may be generated (for example indicating a persistent, slow leak).

The gateway 410 may also monitor the weight of the container to determine the amount of water remaining in the container. If the remaining amount passes below a pre-defined value, the gateway 410 may send a message or alert signaling need for replacement of the container/bottle. The messages or alerts, transmitted by the transceiver, may be received at the handheld device 418 of a service worker or to the server 420. The server 420 allows for off-site monitoring of the water dispensing system(s). Additionally, the handheld device 418 and server 420 may communicate with each other to access stored information regarding the water dispensing system, such as service records, monitored operation data, system messages or alerts. The gateway 410 may also be operatively in communication with a user interface on the stand of the water dispensing system for displaying alert information processed and/or stored by the gateway 410 as well as any error messages and alerts generated by the gateway 410.

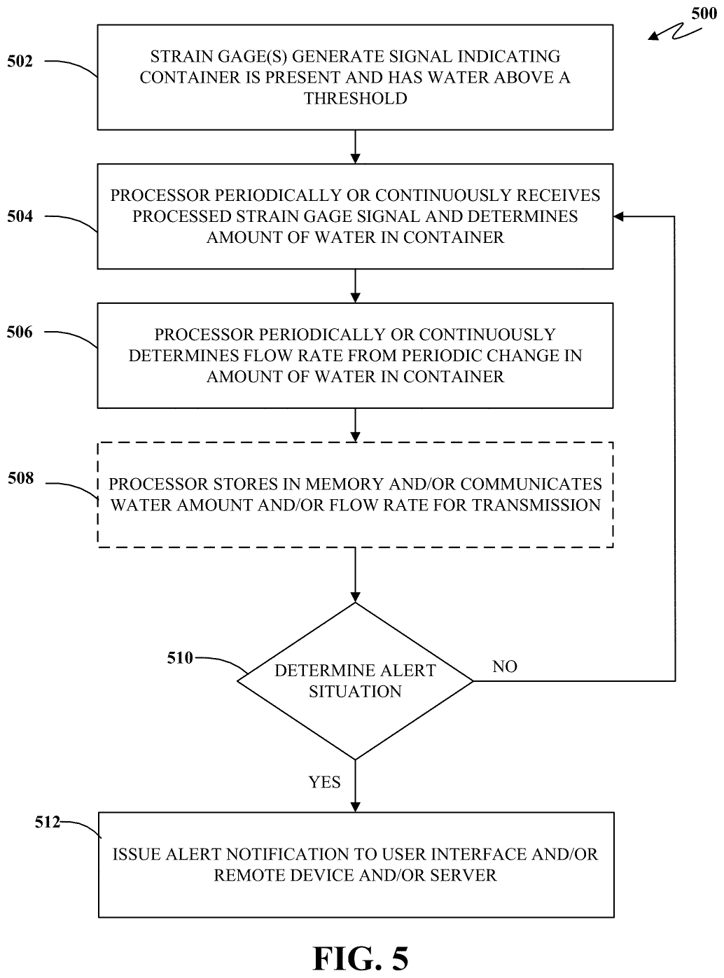

FIG. 5 illustrates a flow diagram for operation 500 of an embodiment of a system and method for strain gage water monitoring in a water dispensing system according to the disclosure. The water dispensing system may detect whether a container is present 502, or is above a certain level/threshold, using the strain gage signal as read (and conditioned) and compared to a pre-determined control value. When a container with water is disposed in the system, the conditioned/digitized strain gage signal may be received periodically or continuously 504, e.g., via periodic polling by the micro-controller or continuous delivery of the processed strain gage signal to an input of the micro-controller, and the micro-controller determines the amount (force or weight) of water in the container.

As water is drawn from the container, the micro-controller associated with the gateway receives updated/changed strain gage signals, representing the change in weight over time, and determines the flow rate of water 506 within the system. Flow rate may be determined over periods, e.g., beginning with a threshold change detected from the strain gage signal such as occurs upon opening a spigot. The strain gage signal may change in an amount that may signify beginning of a time period during which signal change/flow may be monitored, so that the rate of flow during any period may be monitored. Periodic flows may be aggregated to determine an aggregate amount of water dispenser from the system. Individual flow period data may be stored in micro-controller associated memory 508 and/or communicated to the service worker hand held device and/or the server. Flow and consumption data may be available in the server for predicting when a container may need to be replaced, and aggregated consumption data may be used to plan deliveries and maintain stock of bottles/containers.

Referring still to FIG. 5, amount of water in the container or flow rate information as determined by the micro-controller based on strain gage signal(s) may be used to determine Alert situations 510. For example, if the flow rate exceeds a threshold value, that is outside a range of expected/known flow rates, a leak may be occurring. In such an instance a service request or alert may be generated by the gateway. Additionally, relative strain on the strain gage(s) may be used to determine the orientation (e.g., proper or improper seating) of the container. If the container is not in a predefined position/orientation, the container may be improperly installed, necessitating an alert or action to avoid or correct a leak within the system. As the amount of water within the container decreases, a message or alert may be generated upon the remaining amount reaching or exceeding a predetermined amount. An alert indicator may be issued to a user interface programmed to display a color or shape to represent the remaining amount within the container. Additionally, a message or alert may be displayed if the water dispensing system detects the container is improperly installed or a leak is present.

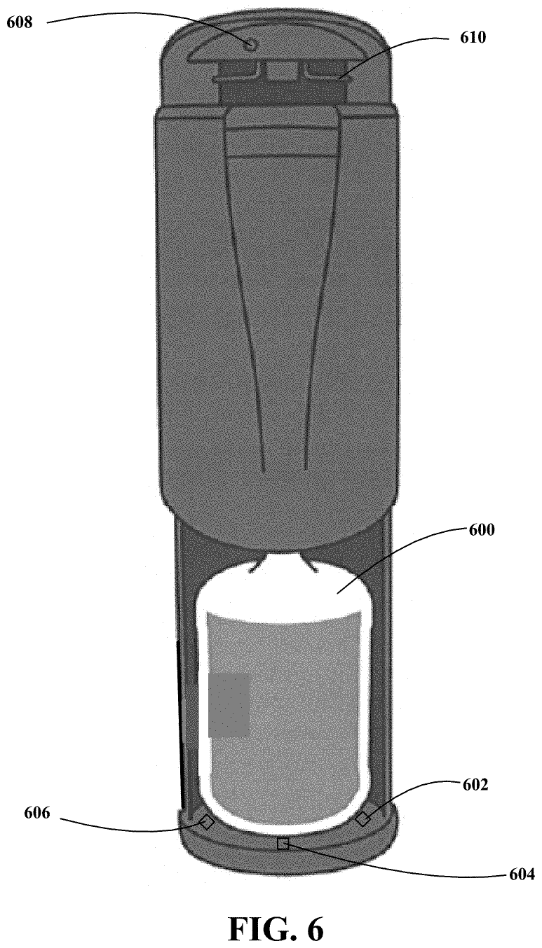

FIG. 6 illustrates an embodiment of the present disclosure using a bottom loading configuration. The system operates similarly to the embodiment disclosed hereinbefore, however, the system has a container or bottle 600 located at the bottom of the dispenser, and the bottle/container is not inverted. The strain gage(s) 602, 604, 606 may be disposed below a base of the container (directly or indirectly), e.g., on a floor of a cabinet in which the container is disposed. The cabinet may enclose the container to limit access and/or contamination of the container. The cabinet may be an integrated portion of the stand and be located below the dispenser unit. Otherwise, strain gage monitoring and operation is as described hereinbefore. An indicator light or user interface 608, located on the dispenser, may display information generated by the gateway, as described hereinbefore, to inform the system user of status (e.g., empty, full, Alert) of the water dispensing system. The water dispensing system may include handle(s) or lever(s) 610 for opening spigot(s). It should be appreciated that the handles may be replaced by capacitive buttons or traditional spigots without deviating from the present disclosure.

The bottom loading configuration may also include a pump (not shown) internal to the water dispensing system for moving the water within the system. The pump may be in fluid communication with a hose or conduit (not shown) for inserting into the container. If the system uses a hose or conduit, the gateway may be configured to compensate any added weight when determining water amount or flow rate based on output of the strain gage(s).

Although strain gages are described herein in use for determining water amount in a container and flow rate of water from a container, it should be appreciated that the system may utilize one or more of the strain gages to detect the position of the container. The monitoring of the location and angle of the container may be detected using the strain gages, and used to determine whether the container has formed a seal with the receiver or if a leak may be present.

It should be appreciated that a variety of different sensors and techniques can be used to determine relative amount of water left in the container/bottle. For example, in one instance alternative strain gages in combination, or in combination with a load cell may be used to determine the percent amount of water left in the bottle based on the relative weight of the remaining fluid. In other embodiments a strain gage may be used in conjunction with simple sensors such as Infrared emitters and receivers or Ultrasonic emitters and receivers may be used to accurately determine the amount of water left in a bottle.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to components. Of course, if the component is inverted, above becomes below, and vice versa. Additionally, if oriented sideways, above and below may refer to sides of a component. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

It should be understood that when an element is referred to as being “connected” or “coupled” to another element (or variations thereof), it can be directly connected or coupled to the other element or intervening elements may be present.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The words “illustrative” or “exemplary” are used herein to mean “serving as an example, instance, or illustration.” Any aspect described herein as “illustrative” or “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor configured to perform the functions discussed in the present disclosure. The processor may be a micro-controller, an application specific integrated circuit (ASIC), a field programmable gate array signal (FPGA) or other programmable logic device (PLD), discrete gate or transistor logic, discrete hardware components or any combination thereof designed to perform the functions described herein. The processor may be a microprocessor, controller, microcontroller, or state machine specially configured as described herein. Those skilled in the art will recognize how best to implement the described functionality for the processing system depending on the particular application and the overall design constraints imposed on the overall system.

The steps of a method or algorithm described in connection with the present disclosure may be embodied directly in hardware, in a software module executed by a processor, or in a combination of the two. A software module, or any data, may reside in storage or machine readable medium, including random access memory (RAM), read only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module, it will be understood that such functionality is implemented by the processor when executing instructions from that software module. Furthermore, it should be appreciated that aspects of the present disclosure result in improvements to the functioning of the processor, computer, machine, or other system implementing such aspects.

It should be appreciated that for the purposes of transmission of data or information, although particular wireless technologies may be mentioned in the disclosure, data or information may be transmitted to/from a website, server, or other remote source using wired or wireless technologies, such as a coaxial cable, fiber optic cable, twisted pair, digital subscriber line (DSL), or wireless technologies such as infrared (IR), radio, and microwave.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. A water dispenser system dispensing water from a removable container comprising:
a stand;
a receiver disposed in the stand configured to receive a removable container;
at least one strain gage disposed in the receiver and operatively configured to measure a force exerted by the removable container on the at least one strain gage and provide a strain gage signal;
at least one spigot in fluid communication with the removable container and configured to allow water to flow from the removable container and be dispensed from the water dispenser system;
a processor operatively connected to the at least one strain gage, the processor configured to receive the strain gage signal, and to determine an amount of water in the removable container using the strain gage signal, the processor further configured to calculate a flow rate of water exiting the removable container using a plurality of strain gage signals received from the at least one strain gage over time, the processor being further configured to generate alert information comprising at least one of a measurement of amount of water in the removable container and the flow rate of water exiting the removable container.

2. The water dispenser system of claim 1 further comprising:
a well formed in the receiver;
at least one reservoir in fluid communication with the well and disposed within the stand for storing a predetermined amount of water from the removable container, and the at least one reservoir in fluid communication with the at least one spigot for dispensing the water.

3. The water dispenser system of claim 1 wherein the receiver further comprises an air filter configured to allow air to enter the receiver and displace water in the removable container as the water exits the removable container.

4. The water dispenser system of claim 1 further comprising:
a gateway comprising a transceiver operatively connected to the processor, the gateway configured to generate an information packet comprising the alert information and to send the information packet to a server.

5. The water dispenser system of claim 4 wherein the processor is further configured with at least one predefined threshold value for comparing to a flow rate value of water exiting the removable container to determine whether a leak is present in the water dispenser system.

6. The water dispenser system of claim 1 further comprising a gateway comprising a transceiver operatively connected to the processor, the gateway configured to generate an information packet comprising the alert information and to send the information packet to a handheld device.

7. The water dispenser system of claim 1 further comprising a user interface disposed on the surface of the stand, the user interface configured to display the alert information.

8. A water dispenser system dispensing water from a removable container, comprising:
a stand;
a receiver configured to receive the removable container, the receiver comprising at least one strain gage operatively configured to produce a strain gage signal generated by a force exerted by the removable container on the at least one strain gage;
a processor configured to receive the strain gage signal and determine at least one of a measurement of an amount of water in the removable container and a flow rate of water exiting the removable container;
at least one spigot in fluid communication with the removable container and configured to allow water to selectively flow from the removable container.

9. The water dispenser system of claim 8, wherein the removable container is a bottle.

10. The water dispenser system of claim 8, wherein the removable container is positioned in one of direct or indirect contact with the at least one strain gage to produce a strain gage signal.

11. The water dispenser system of claim 8 further comprising: a gateway comprising a transceiver operatively connected to the processor, the gateway configured to receive from the processor an information packet comprising at least one of an amount of water in the removable container and a flow rate of water exiting the removable container.

12. The water dispenser of claim 11 wherein the processor is further configured with at least one predefined threshold value for comparing to a determined flow rate of water exiting the removable container to determine whether a leak is present in the water dispenser system.

13. The water dispenser of claim 8 further comprising:
a gateway comprising a transceiver operatively connected to the processor;
the processor further configured with at least one predefined threshold value for comparing to a determined flow rate of water exiting the removable container to determine whether a leak is present in the water dispenser system, and to generate an error message if the processor determines a leak is present;
the gateway configured to receive an information packet comprising at least one of a calculated amount of water in the removable container, the flow rate of water exiting the removable container, and the error message;
the gateway further configured to send the information packet to a handheld device.

14. A method for determining an amount of water dispensed from a removable container in a water dispenser system, the method comprising the steps of:
configuring a receiver to receive the removable container;
positioning at least one strain gage proximate to the receiver;
configuring the at least one strain gage to measure a force exerted by the removable container on the at least one strain gage;
configuring a processor to receive a strain gage signal from the at least one strain gage, and to determine an amount of water in the removable container using the strain gage signal, and to determine a flow rate of water exiting the removable container using a plurality of strain gage signals over time.

15. The method of claim 14 further comprising the steps of:
installing a well fluidly connected to at least one reservoir for storing the water received from the removable container in the water dispenser system; and
connecting in fluid communication the at least one reservoir to at least one spigot disposed on the stand.

16. The method of claim 14 further comprising the steps of:
configuring the processor to compare a determined flow rate of water exiting the removable container to at least one predefined threshold value to determine whether a leak is present in the water dispenser system, and to generate an error message if the processor determines a leak is present in the water dispenser system.

17. The method of claim 16 further comprising the steps of:
configuring a user interface to display at least one of amount of water in the removable container, flow rate of water exiting the removable container, and the error message.

18. The method of claim 16 further comprising the steps of:
configuring a gateway to transmit an information packet to a server, the information packet comprising at least one of measurement of amount of water in the removable container, flow rate of water exiting the removable container, and the error message.

19. The method of claim 17 further comprising the steps of:
detecting, using the at least one strain gage, if the removable container is mounted improperly; and
displaying a mounting alert when the processor determines the removable container is mounted improperly.
